(19) United States
(12) Patent Application Publication
(10) Pub. No.: US 2010/0021677 A1
(43) Pub. Date: Jan. 28, 2010

(54) Method of encapsulating a post

(76) Inventors: Robert Andrew West, South Australia (AU); David Scott MacDonald, Victoria (AU)

Correspondence Address: KLAUBER & JACKSON, 411 HACKENSACK AVENUE, HACKENSACK, NJ, 07601, US

(21) Appl. No.: 11/887,180

(22) PCT Filed: Mar. 29, 2006
(86) PCT No.: PCT/AU2006/000413

§ 371 Date: Jun. 15, 2009

(30) Foreign Application Priority Data
Mar. 29, 2005 (AU) 2005901494

(51) Int. Cl. B32B 21/08; B05D 5/00; B05D 3/12; B05D 3/00; B05C 11/00

(52) U.S. Cl. 428/76; 427/256; 427/289; 427/300; 118/668

(57) ABSTRACT

A method and apparatus is disclosed enabling a length of wood such as a post to be encapsulated in a coating such as plastic. The method involves placing end caps at the ends of the post and coating the resulting assembly. The method also provides for encapsulating a plurality of posts in a production line.

### TECHNICAL FIELD

This invention relates to the coating of lengths of wood in a material such as plastic.

### BACKGROUND TO THE INVENTION

Many industries use materials which over time, perish or become otherwise unsuitable for continued use. One such industry is the wine industry which uses posts made of wood such as timber to provide a support structure to support the vines producing the grapes for the wine.

Over time, these posts may begin to perish and/or are damaged by machines which are used to pick the grapes from the vines. In such cases, the posts must be replaced with new posts. This can be a relatively expensive exercise as material such as timber can be costly.

In order to minimise the degradation of the timber, the timber is often treated with materials such as arsenic and creosote. These substances make the timber more resilient to the environment however, are toxic. This can cause serious problems to the environment if the chemical leaches into the ground and surrounding region. Furthermore, the use of such chemicals complicates the storage and/or disposal of damaged posts. In particular, damaged posts must be stored on a concrete or otherwise impermeable surface rather than on the ground to prevent the chemicals from leaching into the ground.

Even more seriously, the disposal of these damaged posts is complicated because burying of the posts results in a potential contamination hazard to the environment surrounding the burial site, while burning of the posts results in toxic fumes being produced and released into the atmosphere. Neither solution is acceptable and in fact, in some cases, is against regulatory requirements.

Alternative materials which are more resilient to the environment, such as plastics, have been used in an attempt to replace the chemically-treated wooden posts. While this addresses one of the problems, the plastic material is susceptible to other forms of environmental attack, particularly from exposure to sunlight. This can cause the plastic to degrade and weaken, causing the post to become deformed and less suitable for use as a support mechanism.

Accordingly, it is an object of the present invention to provide a method and product which can address some of the problems discussed above.

### SUMMARY OF THE INVENTION

According to a first aspect of the present invention, there is provided a method of coating a length of wood having a first end and a second end, in a coating, the method including:
placing a first end cap at the first end of the length of wood;
placing a second end cap at the second end of the length of wood; and
at least partially coating the length of wood, including at least a part of the first and second end caps.

Preferably, the method further includes completely coating the length of wood and at least a portion of the end caps with the coating such that the length of wood is entirely covered by the coating and the first and second end caps.

Preferably, the coating is plastic.

Preferably, the plastic is polyethylene.

Preferably, the plastic is UV-resistant.

Optionally, the length of wood is a post.

Alternatively, the length of wood is a plank.

According to a second aspect of the present invention, there is provided a method of coating a length of wood having a first end and a second end, in a coating, the method including:
placing a first spacer between an end of a first length of wood and the first end of the length of wood;
placing a second spacer between the second end of the length of wood and an end of a further length of wood; and
coating at least a portion of the first length of wood, the length of wood and at least a portion of the further length of wood, including the first and second spacers, in the coating.

Preferably, the method further includes cutting through each of the first and second spacers to separate the length of wood from the first length of wood and the further length of wood.

Preferably, the step of coating results in covering the entire length of wood, including at least a portion of each of the spacers, such that the length of wood is entirely covered by the coating and the first and second spacers.

Optionally, the length of wood is a post.

Alternatively, the length of wood is a plank.

According to a third aspect of the present invention, there is provided a coated length of wood produced according to the method of the first aspect of the present invention.

According to a fourth aspect of the present invention, there is provided a coated length of wood produced according to the method of the second aspect of the present invention.

According to a fifth aspect of the present invention, there is provided a machine for coating a length of wood, the machine including:
means for applying an amount of coating about a first length of wood, the length of wood, and a further length of wood, the first length of wood separated by a first spacer and the length of wood and the further length of wood separated by a second spacer;
means for detecting the location of the first spacer and the second spacer; and
means for cutting through the first spacer and the second spacer to separate the coated length of wood from the first length of wood and the further length of wood.

Preferably the machine further includes means for disposing a first spacer between the first length of wood and the length of wood, and the second spacer between the length of wood and the further length of wood.

Preferably, the means for detecting the location of the first spacer and the second spacer includes means for detecting an irregularity in the surface of the coated first length of wood, the length of wood and the further length of wood.

According to a sixth aspect of the present invention, there is provided a coated length of wood made by the machine of the fifth aspect of the present invention.

According to a seventh aspect of the present invention, there is provided a coated length of wood including:
the length of wood;
an end cap disposed at each end of the length of wood; and
a coating surrounding at least a portion of the length of wood at least a portion of each end cap.

Preferably, the coating is a plastic.

Preferably, the plastic is polyethylene.

Preferably, the coating is UV resistant.

Preferably, the end caps are of the same material as the coating.

### BRIEF DESCRIPTION OF THE DRAWINGS

A preferred embodiment of the invention will now be described with reference to the following Figures in which:

FIG. 1—shows a coated length of wood according to an aspect of the present invention;

FIG. 2—shows a cross-sectional view of the coated length of wood of FIG. 1;

FIGS. 3A to 3C—show a perspective view, a side view and a plan view of an end cap used in one aspect of the present invention;

FIGS. 4A to 4C—show a perspective view, a side view and a plan view of an alternative end cap according to one aspect of the present invention;

FIG. 5—shows an alternative coated length of wood according to an aspect of the present invention;

FIG. 6—shows a modified end cap of FIG. 3;

FIG. 7—shows a modified end cap of FIG. 4;

FIG. 8—shows a cross-sectional view of a coated length of wood using the end cap illustrated in FIG. 6;

FIG. 9—shows an example arrangement of equipment used to produce a post of the present invention;

FIGS. 10A to 10C—show the spacer used in the present invention;

FIG. 11—shows a close-up of the spacer between two posts;

FIG. 12—shows the arrangement of FIG. 3 encapsulated in plastic;

FIG. 13—shows a post resulting from a method of the present invention;

FIGS. 14A to 14C—show an alternative of the spacer of FIG. 2; and

FIG. 15A to 15C—show a further alternative to the spacer of FIG. 2;

### DETAILED DESCRIPTION OF THE PREFERRED EMBODIMENT

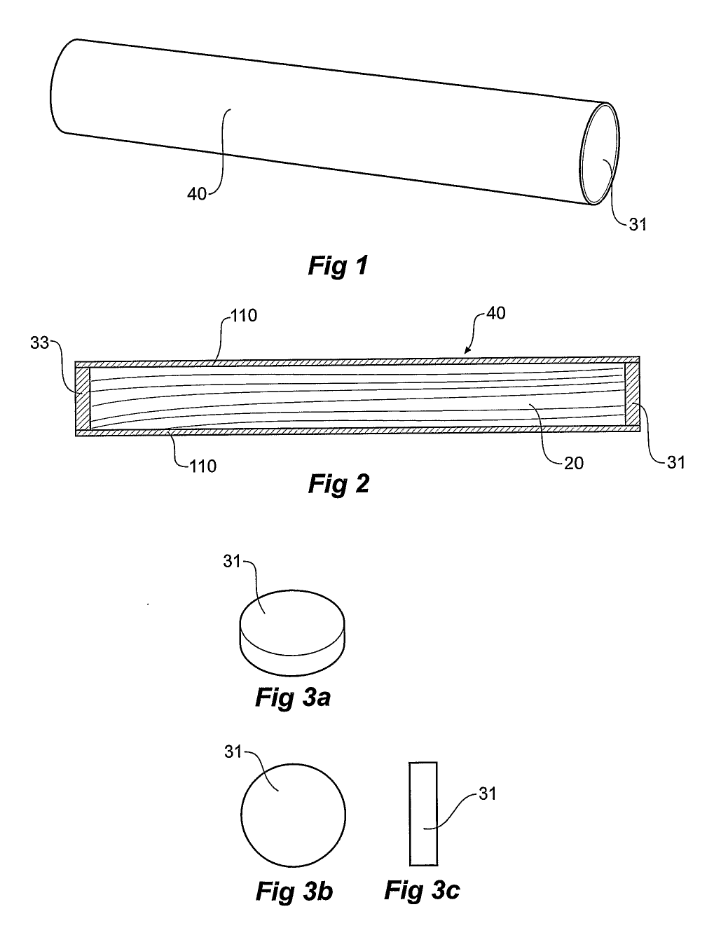

FIGS. 1 and 2 show a length of wood 20, in this case a post, encased in a plastic coating 110, to provide coated length of wood or post 40. FIG. 1 is a perspective view of the coated post 40, while FIG. 2 is a cross-sectional view of the post of FIG. 1.

As can be seen, the length of wood is completely sealed in the plastic coating, including the ends. According to one aspect of the present invention, the ends of the post 40 are provided with end caps 31 and 33. These end caps are applied to the ends of the length of wood 20, and then the plastic coating 110 is applied to cover both the length of wood and at least the join between the end of the post and the end caps 31, 33. In this way, a post or other length of wood is able to be completely sealed if desired.

The plastics material may be any suitable material, including polyethylene, polyvinylchloride, polypropylene, an ethyl-vinyl chloride polymer or ABI-resin. The material used will preferably be UV resistant (eg black polyethylene) so as to minimise degradation once in use due to exposure to sunlight. If the plastic used is not black in colour, UV stabilisers could be added, however, this would add to the cost of the process.

Again, while a plastics material is preferred, any other suitable material may be used.

FIGS. 3A to 3C show end cap 31 in more detail. End cap 31 may be shaped to match the end of the length of wood to which it will be applied as will be understood by the person skilled in the art. FIG. 3A shows a perspective view of the rectangular end cap 31, while FIGS. 3B and 3C show side and plan views respectively.

End cap 31 is a disc made of the same plastic in which the post 20 is to be coated. End cap 33 is identical to end cap 31. Of course, materials different to the coating material may be used to make end caps 31 and 33, however, there are specific advantages in having the materials the same, as will be described in more detail below.

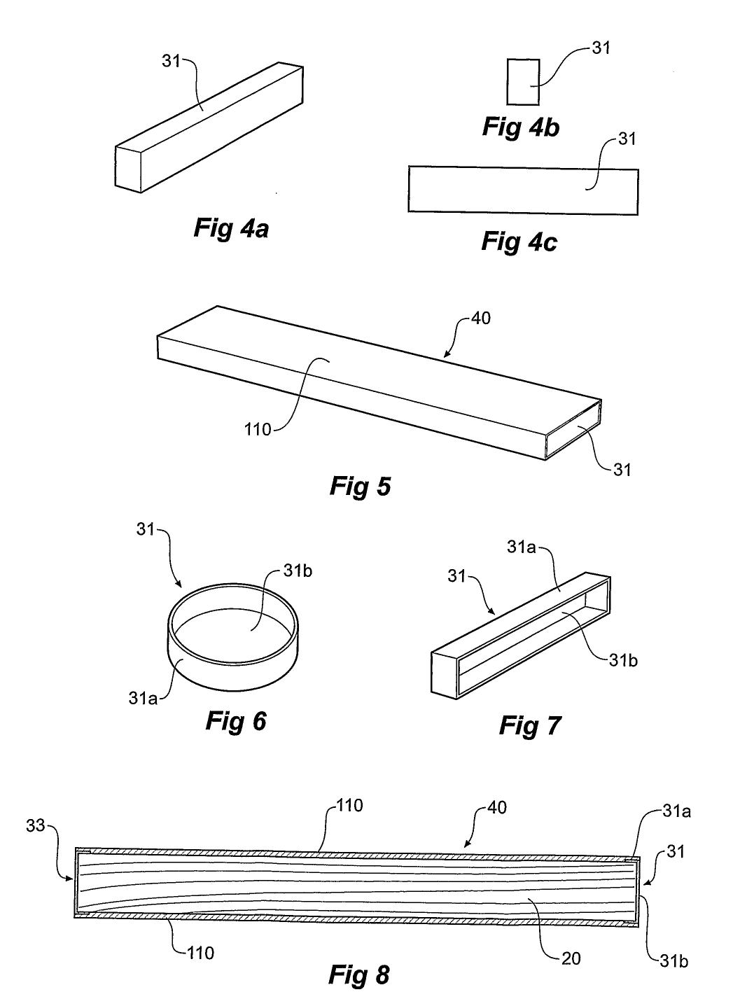

FIGS. 4A to 4C show an alternative form of the end cap 31 of FIG. 3. In FIG. 4, the end cap 31 is provided as a rectangular block. This end cap is suitable for application to a length of wood having a rectangular end, such as a plank.

FIG. 4A shows a perspective view of the rectangular end cap 31, while FIGS. 4B and 4C show side and plan views respectively.

It will be understood that end caps 31 and 33 will be able to be made in any suitable configuration to suit the length of wood being coated.

FIG. 5 shows a perspective view of a length of wood, in this case a plank, that has been coated according to an aspect of the present invention, including the end caps 31 and 33 (not visible in this view) of FIGS. 4A to 4C.

FIG. 6 shows an alternative of the round end cap 31 of FIGS. 3A to 3C. In this embodiment, the end caps are not solid disks, but are more like caps normally used on bottles or jars. This end cap 31 has a lip 31a and a top 31b defining a hollow region. This end cap 31 is placed over the end of the length of wood, which is received within the hollow region.

FIG. 7 shows an end cap of the form of FIG. 6 shaped like the end cap of FIGS. 4A to 4C, to be applied to or fitted over an end of a plank. End cap 31 in this configuration also has lip 31a and top 31b.

FIG. 8 is cross-sectional view of a length of wood or post 20 coated in plastic 110. This is the same view as the coated post in FIG. 2, except that in this embodiment, end caps 31 and 32 are of the form described with reference to FIG. 6.

Looking at end cap 31 in FIG. 8, it can be seen that the end of the length of wood or post is received in the hollow defined by lip 31a and top 31b. Plastic material 110 is then applied to coat post 20 and at least part of the overlap of lip 31a and post 20. In practice, the plastic coating 110 could extend right up to the edge of top 31a.

A similar arrangement will be produced if the length of wood is a plank or other-shaped length of wood, rather than a cylindrical post.

The aspect of the invention described above can be applied to individual lengths of wood. According to another aspect of the present invention however, the invention can be applied to a plurality of lengths of wood. According to this aspect of the invention, a production line can be provided to automate the process of coating multiple lengths of wood.

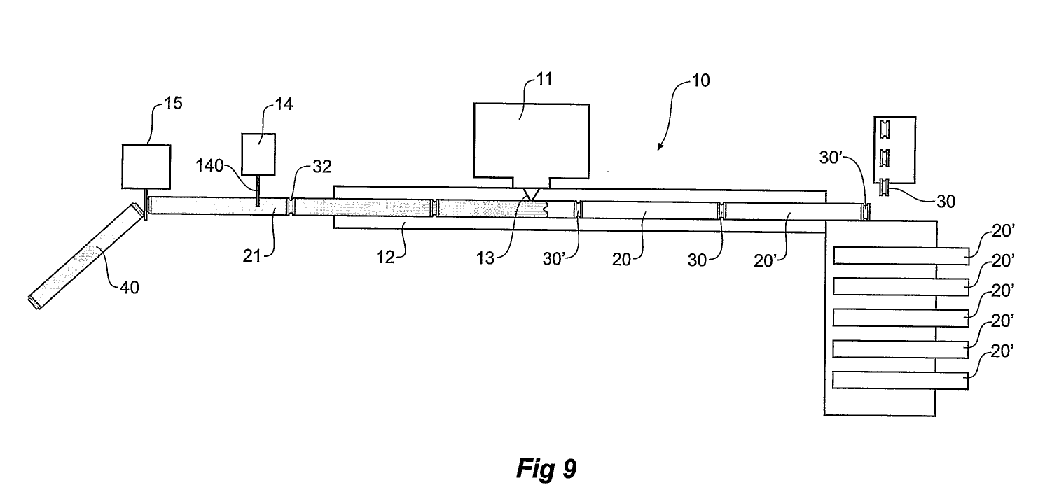

FIG. 9 shows an arrangement 10 to carry out one method of the present invention on a production scale. Wooden posts 20 are arranged in magazine-fashion to be fed into plastics extruder 12 to be coated in plastic. It is preferred that posts 20, 20′ are dried before processing, so that steam or other gases do not form during the coating process or when exposed to the sun when in use. This could result in the separation of the plastics coating from the pole.

As post 20 is fed into the end of extruder 12, a spacer 30 is located at the end of post 20 and the post/spacer is inserted completely into extruder 12. A second post 20′ is then fed into extruder 12 directly behind post 20, sandwiching spacer 30 therebetween. A further spacer 30′ is then placed behind post 20′ and so on and so forth.

Preferably, the spacer 30 is attached to the end of post 20. This may be done by any suitable means. For example, the spacer 30 could be secured to post 20 by a suitable adhesive which is automatically applied just prior to placing spacer 30 onto the end of post 20. Alternatively, the surface of the ends of spacer 30 may have projections which can pierce the end of post 20 upon being pushed hard against the end of post 20, or spacer 30 may be secured by way of a nail using a conventional automatic nail gun. It will be appreciated that the securing of spacer 30 to post 20 need not be a strong one, but is preferred to maintain a reasonable connection between post 20 and spacer 30 until they are sealed together by the plastics material.

Spacers 30′ are stored in a magazine arrangement as are posts 20′.

The line of post 20, spacer 30, post 20′, spacer 30′ etc is then fed further into extruder 12, such that it passes by cross head 13, which extrudes a plastic material, so as to coat the line with a plastics material as would be understood by the person skilled in the art.

The plastics material is stored in container 11 and extruded therefrom at cross-head 13.

The plastics material may be any suitable material, including polyethylene, polyvinylchloride, polypropylene, an ethyl-vinyl chloride polymer or ABI-resin. The material used will preferably be UV resistant (eg black polyethylene) so as to minimise degradation once in use due to exposure to sunlight. If the plastic used is not black in colour, UV stabilisers could be added, however, this would add to the cost of the process.

Again, while a plastics material is preferred, any other suitable material may be used.

The material of spacer 30 is preferably the same as the plastic used to coat the posts, so that upon itself being coated, the spacer and coating will melt on the surface and fuse together, providing a strong bond and completely seal the post 20 and surrounding spacers 30 and 30′.

The plastics material in container 11 is heated to a temperature of about 210 degrees Celsius before being extruded to coat the posts. Spacers 30, 30′ may also be pre-heated to facilitate the bonding of the two plastics.

As the line passes cross-head 13 and is coated with the plastic, there results a continuous line of coated posts 20, 20′ and spacers 30, 30′. This is seen in FIG. 1 as line 21.

As will be discussed further below, while line 21 is essentially continuous, its surface exhibits an irregularity at the point where the spacers are, to enable the identification of their location within line 21.

The plastics coating will be applied at a thickness appropriate to the application as will be understood by the person skilled in the art, but will preferably be at least 3 mm in thickness. 5 mm has been found to be ideal for the present application.

Line 21 then proceeds to be cooled (eg in a bath or shower of water) to ensure that the line 21 is sufficiently cool to allow cutting (see further below) in to individual encapsulated poles.

The plastics coating will in fact also shrink as it cools, further ensuring a tight seal around post 20 and spacers 30, 30′.

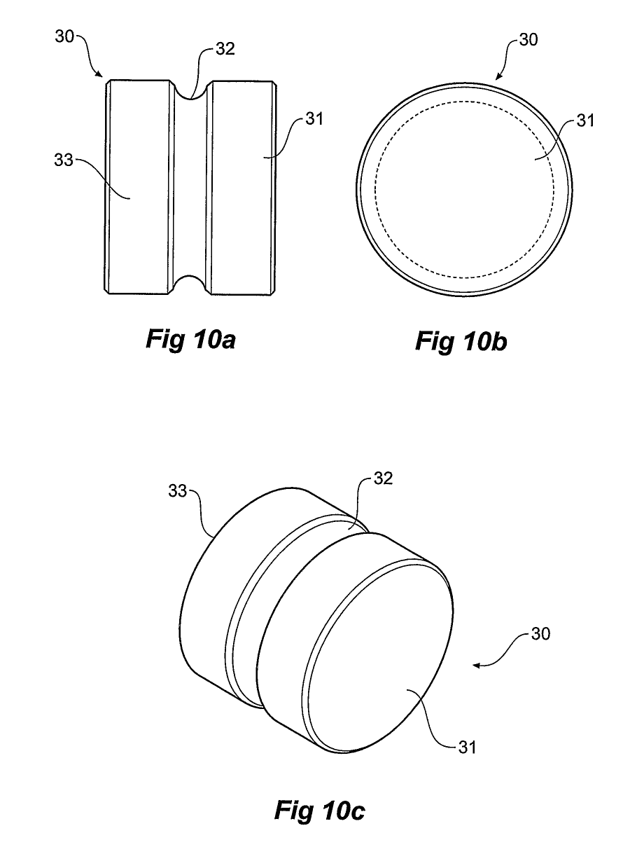

Turning now to FIGS. 10A to 10C, there is shown spacer 30 in detail. Spacer 30 consists of a circular module with a depression 32 surrounding the mid-circumference of the spacer. It will be appreciated that the ends of spacer 30, when separated, provide end caps 31 and 33 described above in relation to the previous aspect of the invention.

The surface of spacer 30 may be ribbed or textured to provide a greater surface area and thereby greater bonding between the spacer and the plastics coating, if required.

It is also possible for spacer 30 to be different sizes and in particular, different lengths. This can be useful if posts 20 are of different lengths and spacers of different lengths may then be used to compensate for length irregularities to provide for encapsulated posts of more uniform length.

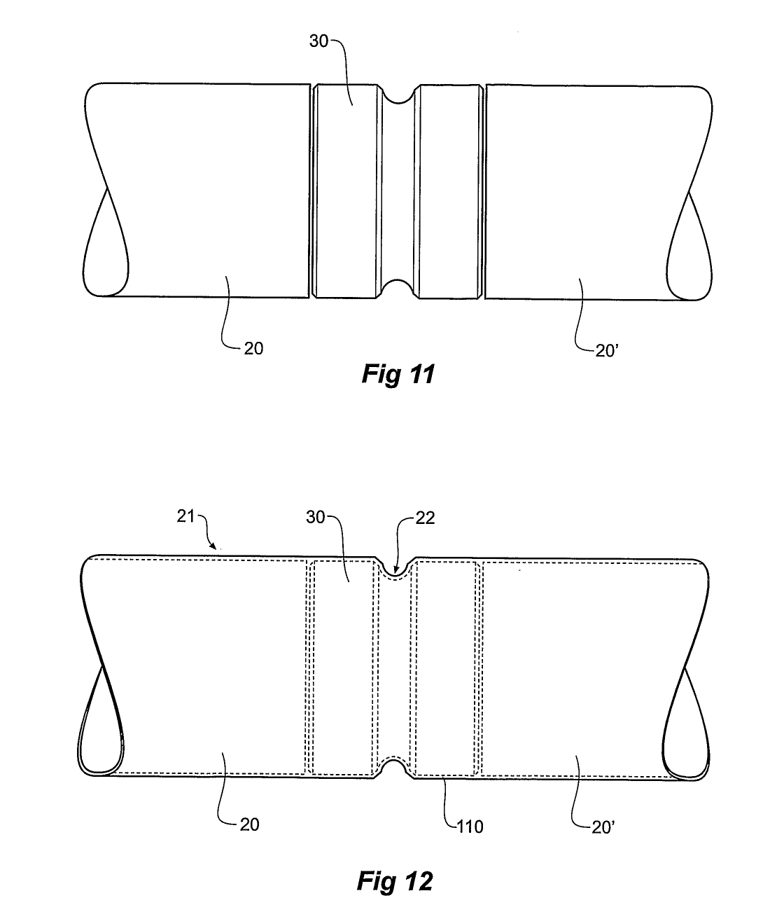

In use, spacer 30 is placed at one end of post 20, and a further post 20′, will then be placed against the other end of spacer 30 as described above and shown in more detail in FIG. 11.

After coating with the plastics material, there results a continuous line 21 of post and spacer, encapsulated by the plastic 110, as can be seen in FIG. 12. Also visible is a depression or irregularity 22 in the surface of line 21. This is caused by depression 32 in spacer 30 as described above with reference to FIG. 10. Of course, the irregularity could take on any convenient form, including a protrusion, or particular pattern.

The reason for irregularity 22 is to allow the position on spacer 30 within line 21 to be determined. This is because the line 21 must then be cut to separate the different posts 20, 20′ from each other.

Referring again to FIG. 9, there is shown spacer identifying block 14, which could comprise any suitable means of identifying spacer 30 within encapsulated line 21. For example, block 14 could include a mechanical finger 140 which runs along the smooth surface of encapsulated line 21, but which is deflected upon encountering irregularity 22. This deflection could be a negative deflection if irregularity 22 is a depression or a positive deflection if irregularity 22 is a protrusion. Finger 140 could also vibrate if irregularity 22 results in a pattern of deformations.

Of course the identifying means could also be provided by any other suitable means such as a laser arrangement which is aimed at a detector on the other side of line 21, which is blocked by the regular surface of line 21 but allowed to pass through momentarily as irregularity 22 passes by.

Alternatively, identifying means 14 may be a metal detector which may detect the presence of a nail if nails are used as a securing means as discussed above.

Upon detecting the presence of irregularity 22, a signal is sent to cutting mechanism 15 to cut through spacer 30 to separate pole 20 from its previous and subsequent poles 20′.

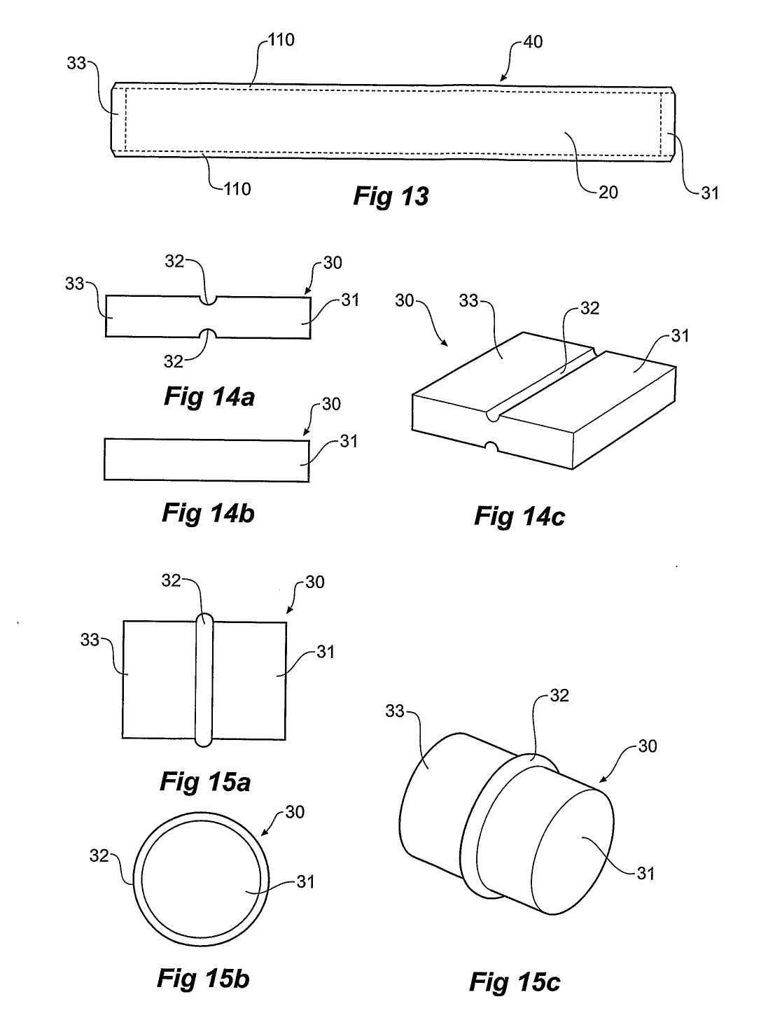

The resulting product is a plastics encapsulated post 40 (see FIG. 13) including wooden post 20, and the two half spacers (or end caps) 31 and 33 (from corresponding ends of two different spacers 30, 30′), all encapsulated by plastic coating 110.

FIGS. 14A to 14C show a variation of the spacer 30, for use where the lengths of wood loaded into the system 10 are planks. FIG. 14A shows a side view, showing two portions 31 and 33, separated by indentation 32.

FIG. 14B shows an end view, which is essentially shaped to be commensurate with the end of the plank 20.

FIG. 14C shows a perspective view of this spacer.

A further embodiment of the spacer 30 of FIGS. 10A to 10C is shown in FIGS. 15A to 15C, where the depression 32 is replaced by a protrusion 32, as previously discussed. This will provide an irregularity on the surface of line 21 in the form of a bump, and can be detected by the irregularity detecting means previously described.

Due to the method of the present invention, the ends of post 20 are also sealed due to the presence of the end caps 21, 33, to provide a completely sealed construction.

While in most applications, it is preferred that a complete seal is provided (for example if the wood post 20 has been treated with toxic materials, or if the encapsulated post is to be used in a harsh environment), it should be understood that apertures or the like could be provided, and that the coating need not be complete to provide a seal.

Post 20 may be a new piece of wood which is being used to provide a strengthening member for plastic coating 110 to provide a composite post 40. Alternatively, post 20 may be a recycled material but need not necessarily have been pre-treated with toxic chemicals.

It will however be appreciated that the maximum benefit of the invention is provided when using recycled wood which has been pre-treated with toxic chemicals, in which, case, plastic coating 110 completely encapsulates post 20 and end caps 31 and 33 to prevent the leaching of the chemicals into the environment.

It will also be appreciated that the plastic material 10 may also be from recycled material, further improving the efficiency of the method of the present invention.

It will also be appreciated that the post 40 can be produced individually by placing end caps 31 and 33 directly onto post 20 and moulding or otherwise coating the entire construction. It will be understood however, the method described above provides for a convenient way of mass-producing completely sealed posts, which would be otherwise extremely difficult to do.

The present invention provides many advantages to both the user of the invention as well as the end consumer. For example, the invention allows the end consumer (for example a vineyard) to dispose of its toxic waste in the form of damaged treated wooden posts, as well as perhaps expired plastic products which may form the basis of plastic casing 110.

Vineyards use large amounts of poly irrigation pipe (LDPE—Low Density Polyethylene) in designing and constructing the irrigation of their vines. A typical amount of plastic used every year by a vineyard is in the order of 40 tonnes. It is also estimated that the Australian wine industry replaces approximately five hundred thousand treated timber posts per year.

The end consumer will also benefit from being able to purchase the processed product to provide posts at a potentially lower rate than existing wooden treated posts. The sealed composite post 40 also relieves the user of the burden of dealing with potentially toxic material in storage, handling, use and disposal.

The user of the invention benefits by being able to source the raw materials from the end consumer, who would conceivably be happy to provide these materials free of charge, and provide the user of the invention with an income from reselling the processed posts back to the end consumer or other end consumers.

While the above has been described with reference to a particular application, it will be understood that the invention is equally applicable to other areas. For example, any product which uses pre-treated wood or other material may benefit from the present invention, for example sleepers and garden edging products.

1. A method of coating a length of wood having a first end and a second end, in a coating, the method including:
placing a first end cap at the first end of the length of wood;
placing a second end cap at the second end of the length of wood; and
at least partially coating the length of wood, including at least a part of the first and second end caps.

2. A method according to claim 1 further including completely coating the length of wood and at least a portion of the end caps with the coating such that the length of wood is entirely covered by the coating and the first and second end caps.

3. A method according to claim 1 wherein the coating is plastic.

4. A method according to claim 3 wherein the plastic is polyethylene.

5. A method according to claim 3 wherein the plastic is UV-resistant.

6. A method according to claim 1 wherein the length of wood is a post.

7. A method according to claim 1 wherein the length of wood is a plank.

8. A method of coating a length of wood having a first end and a second end, in a coating, the method including:
placing a first spacer between an end of a first length of wood and the first end of the length of wood;
placing a second spacer between the second end of the length of wood and an end of a further length of wood; and
coating at least a portion of the first length of wood, the length of wood and at least a portion of the further length of wood, including the first and second spacers, in the coating.

9. A method according to claim 8 further including cutting through each of the first and second spacers to separate the length of wood from the first length of wood and the further length of wood.

10. A method according to claim 8 wherein the step of coating results in covering the entire length of wood, including at least a portion of each of the spacers, such that the length of wood is entirely covered by the coating and the first and second spacers.

11. A method according to claim 8 wherein the length of wood is a post.

12. A method according to claim 8 wherein the length of wood is a plank.

13. A coated length of wood produced by the method of claim 1.

14. A coated length of wood according to claim 13 wherein the length of wood is a post.

15. A coated length of wood according to claim 13 wherein the length of wood is a plank.

16. A coated length of wood produced by the method claim 8.

17. A coated length of wood according to claim 16 wherein the length of wood is a post.

18. A coated length of wood according to claim 16 wherein the length of wood is a plank.

19. A machine for coating a length of wood, the machine including:
means for applying an amount of coating about a first length of wood, the length of wood, and a further length of wood, the first length of wood separated by a first spacer and the length of wood and the further length of wood separated by a second spacer;
means for detecting the location of the first spacer and the second spacer; and
means for cutting through the first spacer and the second spacer to separate the coated length of wood from the first length of wood and the further length of wood.

20. A machine according to claim 19 further including means for disposing a first spacer between the first length of wood and the length of wood, and the second spacer between the length of wood and the further length of wood.

21. A machine according to claim 19, wherein the means for detecting the location of the first spacer and the second spacer includes means for detecting an irregularity in the surface of the coated first length of wood, the length of wood and the further length of wood.

22. A coated length of wood made by the machine of claim 19.

23. A coated length of wood including:
the length of wood;
an end cap disposed at each end of the length of wood; and
a coating surrounding at least a portion of the length of wood at least a portion of each end cap.

24. A coated length of wood according to claim 23 wherein the coating is a plastic.

25. A coated length of wood according to claim 24 wherein the plastic is polyethylene.

26. A coated length of wood according to claim 23 wherein the coating is UV resistant.

27. A coated length of wood according to claim 23 wherein the end caps are of the same material as the coating.
